(19) United States
(12) Patent Application Publication
(10) Pub. No.: US 2012/0247321 A1
(43) Pub. Date: Oct. 4, 2012

(54) PISTON COMPRESSOR

(75) Inventors: Peter MISSFELDT, Kiel (DE); Peter DAHMS, Schwedeneck (DE); Wolfgang WIEGERS, Steinheim-Hopfigheim (DE)

(73) Assignee: J.P. SAUER & SOHN MASCHINENBAU GMBH, Kiel (DE)

(21) Appl. No.: 13/430,118

(22) Filed: Mar. 26, 2012

(30) Foreign Application Priority Data
Apr. 1, 2011 (EP) 11 002 716.6

(51) Int. Cl. F16J 10/00

(52) U.S. Cl. 92/169.1

(57) ABSTRACT

A piston compressor with one or more pistons (10). The at least piston (10) is a multi-part piston including at least one first part (12) and a second part (14). The first and second parts are manufactured of different materials.

### BACKGROUND OF THE INVENTION

The present invention relates generally to a piston compressor with one or more pistons.

With piston compressors, it is known to apply multi-stage piston compressors, with which a stage-wise compressing is effected in consecutive cylinders, for achieving greater pressures. Since the volume reduces on compressing, the displacement volume reduces from stage to stage. For this, the piston and cylinder are usually reduced with regard to their diameter. The pistons with a smaller diameter also have a lower weight, so that imbalances and vibrations occur with the drive of all pistons via a common crank shaft. For this reason, one strives to achieve a mass compensation between the individual pistons. For this reason, it is known for example to manufacture a first larger piston from aluminum and a second smaller piston from grey cast iron. However, the design of the piston from grey cast iron has the disadvantage that due to a different thermal coefficient of expansion, an undesirable play and sealing problems in the cylinder can occur if the cylinder does not consist of grey cast iron.

### BRIEF SUMMARY OF THE INVENTION

It is therefore an objective of a preferred embodiment of the present invention to improve a piston compressor to the extent that an improved mass compensation between the individual pistons can be achieved.

The above objective is achieved by a piston compressor with one or more pistons, wherein at least one of the pistons is a multi-part piston composed of at least one first and a second part which are manufactured of different materials. Preferred embodiments are to be deduced from the following description and the attached figures.

The piston compressor according to a preferred embodiment of the present invention includes one or more pistons. Thereby, one envisages at least one piston being designed as a multi-part piston. This means that the piston is composed of at least one first part and a second part. Thereby, according to a preferred embodiment of the present invention, one envisages these two parts being designed of different materials. Thus, it is possible to select material with a greater density for at least one of the parts, in order to be able to design a smaller piston in a suitably heavier manner and thus to ensure a weight compensation if several pistons are driven via a common crank shaft. The other part with regard to its material can be selected such that it is optimized with regard to its thermal characteristics and in particular is adapted to the cylinder, so that this part, if it is responsible for the guiding in the cylinder for example, can be designed such that when a heating up occurs, this does not lead to an excessive play between the piston and cylinder.

Preferably, the second part of the piston is manufactured from a material of a greater density than the first part. Thus the second part can effect a greater weight of the complete piston than would be the case with a design of the complete piston from the material of the first part.

Particularly preferably, the first part is a piston skirt and the second part a piston head. If the second part is designed from a material with a greater density, thus the piston head is designed in a heavier manner and leads to a greater weight of the piston, so that the weight of a smaller piston can be increased such that it corresponds essentially to the weight of a larger piston which is manufactured of a material with a lower density, and thus a mass compensation between the pistons can be achieved.

Particularly preferably, the piston skirt is of aluminum and the piston head of steel. The design of the piston skirt of aluminum is particularly suitable if the cylinder is also manufactured of aluminum. Thus, one can succeed in the piston skirt and the cylinder having the same thermal coefficient of expansion, so that an increased play between the piston and cylinder does not occur with a temperature increase. The piston rings serving for the sealing between the piston and cylinder are preferably arranged in the region of the piston head, i.e. on the outer periphery of the piston head. In this region, the piston rings can compensate dimensional changes due to a different thermal expansion between the cylinder and piston head. The piston head is manufactured for example of grey cast iron or stainless steel, in particular of rust-free stainless steel, so that it has a good corrosion resistance.

The first and the second part are particularly preferably screwed to one another. For this, if the first part is a piston skirt and the second part a piston head, one can use screws which extend parallel to the longitudinal axis of the piston through the wall of the piston head and engage into threaded holes in the piston head. Thus, a fixed connection between the piston head and the piston skirt can be realized in a very simple manner.

As described above, the piston compressor preferably includes at least two pistons which are driven by a common crank shaft, wherein a first piston is designed as a single-part piston and a second piston is designed as a multi-part piston according to the preceding description. The single-part piston is thereby designed preferably in a single-piece manner and comprises a piston skirt and a piston head of aluminum, whilst the second piston preferably comprises a piston skirt of aluminum and comprises a piston head of steel. Since preferably the first piston has a larger diameter than the second piston, a mass compensation can be achieved in this manner so that the second piston essentially has the same weight as the first piston.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic view of an entire piston compressor according to a preferred embodiment of the present invention;

FIG. 2 is a sectioned view through a piston of the piston compressor along a piston bolt; and

FIG. 3 is a sectioned view of the piston according to FIG. 2, wherein the view is rotated by 45°.

### DETAILED DESCRIPTION OF THE INVENTION

Certain terminology is used in the following description for convenience only and is not limiting. Unless specifically set forth herein, the terms “a,” “an” and “the” are not limited to one element, but instead should be read as meaning “at least one.” The terminology includes the words noted above, derivatives thereof and words of similar import.

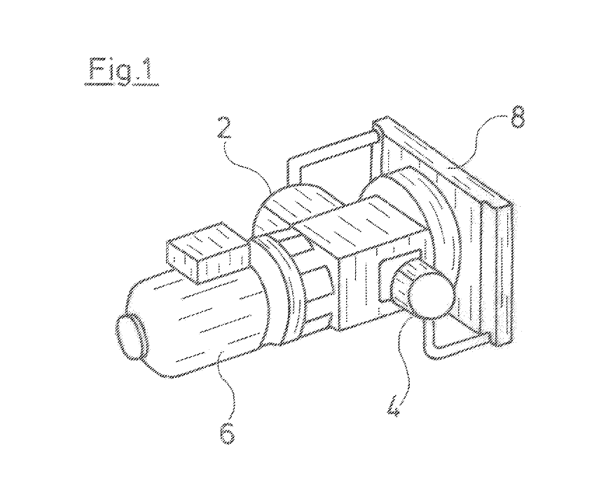

Referring to the drawings in detail, wherein like numerals indicate like elements throughout, FIG. 1 shows the basic construction of a piston compressor, wherein the piston compressor shown here is designed in a two-staged manner with two cylinders 2 and 4. The pistons arranged in the cylinders are driven by an electric motor 6 via a common crank shaft. However, other drives, such as a combustion motor can also be applied. The cylinder 2 forms a first stage of a piston compressor and the gas compressed in the cylinder 2 is led via an intermediate cooler 8 to the cylinder 4 of the second stage. In FIG. 1, one can recognize that the cylinder 4 of the second stage is designed smaller than the cylinder 2, for example, in the inside it has a smaller displacement volume, since the gas entering into the cylinder 4 was already compressed in the first stage, for example, in the cylinder 2. Accordingly, the piston 10 of the second stage also has a smaller diameter than the piston of the first stage.

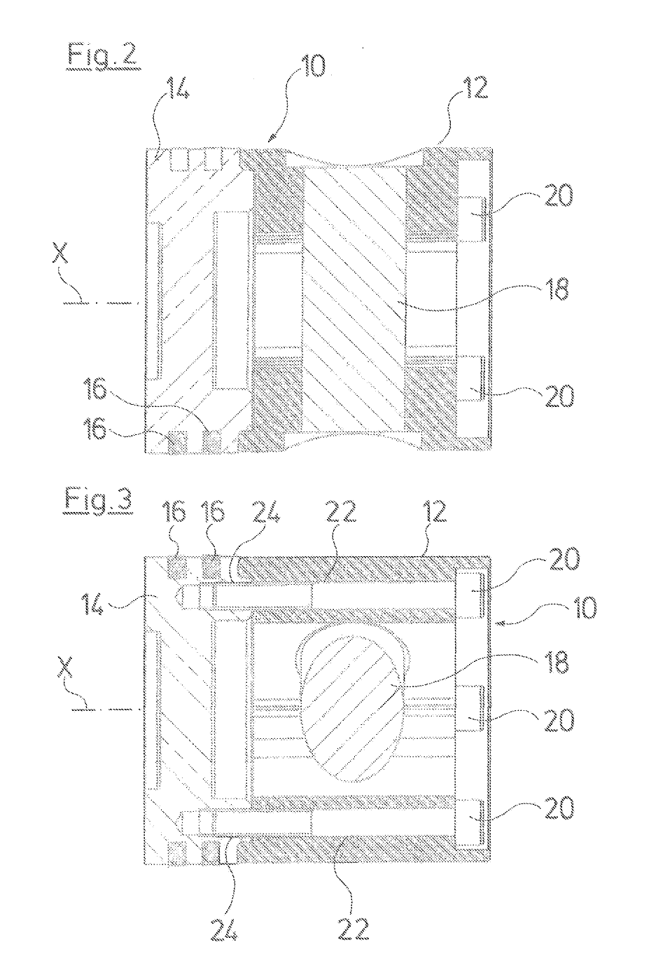

FIGS. 2 and 3 now show the construction of the piston 10, as is applied in the second stage in the second cylinder 4. The piston arranged in the first cylinder 2 can be manufactured in a conventional manner from aluminum. The piston 10 is designed of two parts and includes a piston skirt 12 which forms the first part, as well as a piston head 14 which forms the second part. The piston skirt 12 is manufactured of aluminum and the piston head 14 e.g. of grey cast iron or steel, in particular stainless steel. The piston head 14 on its outer periphery carries the piston rings 16. In the piston skirt 12, the piston bolt 18 is arranged for connection to a push rod or con-rod.

The piston skirt 12 and the piston head 14 are connected to one another via four screws 20, and the screws 20 extend through bores 22 in the piston skirt 12 parallel to the longitudinal axis or movement axis X of the piston 12. The screws 20 then with their thread mesh into the threaded holes 24 in the piston head 14. The screws 20 thus extend over the complete axial length of the piston skirt 12 and fix this on the piston head 14 in a fixed manner. A simple assembly of the piston is possible by way of the screw connection. In the shown embodiment example, four screws 20 are distributed over the periphery of the piston skirt, but it is to be understood that here one can also apply less or more screws 20.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A piston compressor comprising:
at least one piston (10),
wherein the at least one piston (10) is a multi-part piston comprising at least one first part (12) and a second part (14), and
wherein the first part and the second part are manufactured of different materials.

2. The piston compressor according to claim 1, wherein the second part (14) is manufactured of a material of a greater density than the first part (12).

3. The piston compressor according to claim 1, wherein the first part is a piston skirt (12) and the second part is a piston head (14).

4. The piston compressor according to claim 3, wherein the piston skirt (12) is manufactured of aluminum and the piston head (14) is manufactured of steel.

5. The piston compressor according to claim 1, wherein the first part (12) and the second part (14) are screwed to one another.

6. The piston compressor according to claim 1, further comprising at least two pistons driven by a common crank shaft, of which a first piston is a single-part piston, and a second piston is the multi-part piston (10).

7. The piston compressor according to claim 6, wherein the single-part piston comprises a piston skirt and a piston head of aluminum.

8. The piston compressor according to claim 6, wherein the first piston has a greater diameter than the second piston (10).
